(19) United States
(12) Patent Application Publication
(10) Pub. No.: US 2002/0029173 A1
(43) Pub. Date: Mar. 7, 2002

(54) System and method for providing customers with product samples

(76) Inventor: Michael A. Goldstein, Washington, DC (US)

Correspondence Address: Pillsbury Madison & Sutro LLP, Intellectual Property Group, East Tower, Ninth Floor, 1100 New York Avenue, N.W., Washington, DC, 20005-3918, US

(21) Appl. No.: 09/901,094

(22) Filed: Jul. 10, 2001

Related U.S. Application Data
(60) Provisional application No. 60/217,743, filed on Jul. 12, 2000.

(51) Int. Cl. G06F 17/60

(52) U.S. Cl. 705/26

(57) ABSTRACT

A method and system for providing a customer with various different samples of products that are shipped on a subscription basis over a period of time. The different samples of the product are sent to the customer based on the period of subscription. In particular, the invention is directed to a system and method for providing a customer with different samples of publications over a trial, or sample-subscription period. The customer can choose between a predetermined interest category of publications or may choose to formulate a customized personal-interest category. During the sample-subscription period, the customer will then be sent various publications, e.g., a different publication during each delivery cycle, e.g., each month, based on the chosen interest category.

### BACKGROUND OF THE INVENTION

1. Field of the Invention

The present invention generally relates to E-Commerce, and more specifically, to a system and method for providing customers with different samples of publications over a period of time.

2. Description of Related Art

Shopping on the World Wide Web (“Web”) has become increasingly popular and is one of the fastest growing uses of the Internet.

The Web generally operates on a client/server model; that is, a user (e.g., a client) runs a piece of software on his/her personal computer to use the resources of a host (e.g., server computer). The host allows many different users to access its resources at the same time and need not be dedicated to providing resources to a single user. In this model, the client software—e.g., a browser—runs on the user's computer, which contacts a Web server and requests information or resources. The Web server locates and then sends the information or resources to the browser, which displays the results on the user's computer by interpreting the received Hypertext Markup Language (HTML) document.

Users' reference information on the Web is known as Uniform Resource Locators (URLs). A user's browser sends the URL using the Hypertext Transfer Protocol (HTTP), which defines the way the browser and the Web server communicate with each other. When the server finds the requested document, it sends the document back to the user's browser. The requested document, it sends the document back to the user's browser. The information is then presented to the user via the user's computer. In effect, the user requests the services of the host, which may involve searching for information and sending it back to the user by querying a database on the Web, delivering requested Web pages, or shopping on-line.

Currently, consumers can purchase almost anything on-line. In particular, there are Web-sites for ordering books and magazines such as www.Bookofthemonth.com, www.Amazon.com, etc. With these sites, the customers order the books or magazines that they are interested in. Although ordering magazines can be performed on-line, the process of ordering magazines is essentially the same as it is off-line, i.e., through an agent. However, the agent is often transparent to the customer because the customer is actually choosing a publisher's magazine. Therefore, the agent may be just a facilitator of the ordering process.

There are many traditional types of magazine agents, including stamp sheet, telemarketing, cash field and on-line agents. Examples of stamp sheet agents include American Family Publishers® and Publisher's Clearinghouse®. Operating off-line, these agents send out promotional information advertising dozens and dozens of magazines. Consumers respond to the promotional information and order full-term (e.g., twelve, twenty-four or thirty-six month) subscriptions for one or more publications in which they are interested. The monetary compensation for payment for the orders is then sent to the publisher, minus the agent's commission.

Publishers use agents because agents have different marketing mechanisms to reach different consumers in different ways, such as the Web. Therefore, using an agent may adds to the number of consumers to which the publisher can market.

The above-identified types of magazine agents operate on-line as well to sell full-term subscriptions to individual publications. However, as with the other on-line purchasing arrangements described above, the agents are usually transparent to the consumers except for the billing process where the agents bill the customers and then pass that information on to the magazine publishers.

### SUMMARY OF THE INVENTION

An exemplary embodiment of the invention relates to systems and methods that provide customers with different samples of publications, e.g., magazines and other published information, over a period of time, rather than ordering full-term subscriptions to such publications. In particular, exemplary embodiments of the invention may provide systems and methods of providing samples of publications to customers. Such systems and methods may bypass the agents and provide interaction between the customers and publishers. An exemplary embodiment of the invention may allow customers to select a particular category(s) of interest at, for example, a Web-site (which need not be transparent to customers). Subsequently, the software associated with the Web-site may determine, based on the customers' selected interests, which publications to send the customers. Unlike the agents, an exemplary embodiment of the invention may use the interests of the customers, and/or criteria determined by publication publishers to make this determination. Subsequently, according to an exemplary embodiment of the invention, various publications may be sent to the customer each month, each quarter, etc. based on the selected interest category(s).

### BRIEF DESCRIPTION OF THE DRAWINGS

The accompanying drawings, which are incorporated in and constitute a part of this specification, illustrate at least one exemplary embodiment of the invention and, together with the description, explain various advantages and principles of the invention. In the drawings:

FIG. 1 is an illustration of an exemplary computer network on which a system and method for providing customers with various samples of publications may be implemented in accordance with an exemplary embodiment of the invention;

FIG. 2 is a flowchart illustrating a method of providing customers with various samples of publications according to an exemplary embodiment of the invention; and

FIG. 3 is an exemplary diagram used to explain how information is transmitted to a publisher so it can directly send the publications to customer.

### DETAILED DESCRIPTION OF THE INVENTION

One potential benefit of the exemplary embodiments of the invention is that, unlike an agent, which will attempt to sell a subscription for a publication to a customer for a full-term, the exemplary embodiments of the invention may allow a customer to select a general theme or themes that s/he likes and, the customer may receive various publications from the selected theme(s) each month. Subsequently, after the customer has received various different publications over a period of time, an attempt may be made to promote the publications in a manner similar to a conventional agent would, e.g., to sell the customer a full-tern subscription for one or more publications.

The following detailed description refers to the accompanying drawings, which illustrate exemplary embodiments of the present invention. Other embodiments are possible and modifications may be made to the exemplary embodiments without departing from the spirit and scope of the invention. Therefore, the following detailed description is not meant to limit the invention. Rather, the scope of the invention is defined by the appended claims.

As described herein, the utility of present invention extends beyond the traditional publication subscription process by providing an on-line Web-site where customers can select an interest and order various samples of different publications during a subscription term rather than being limited to ordering one publication per subscription term..

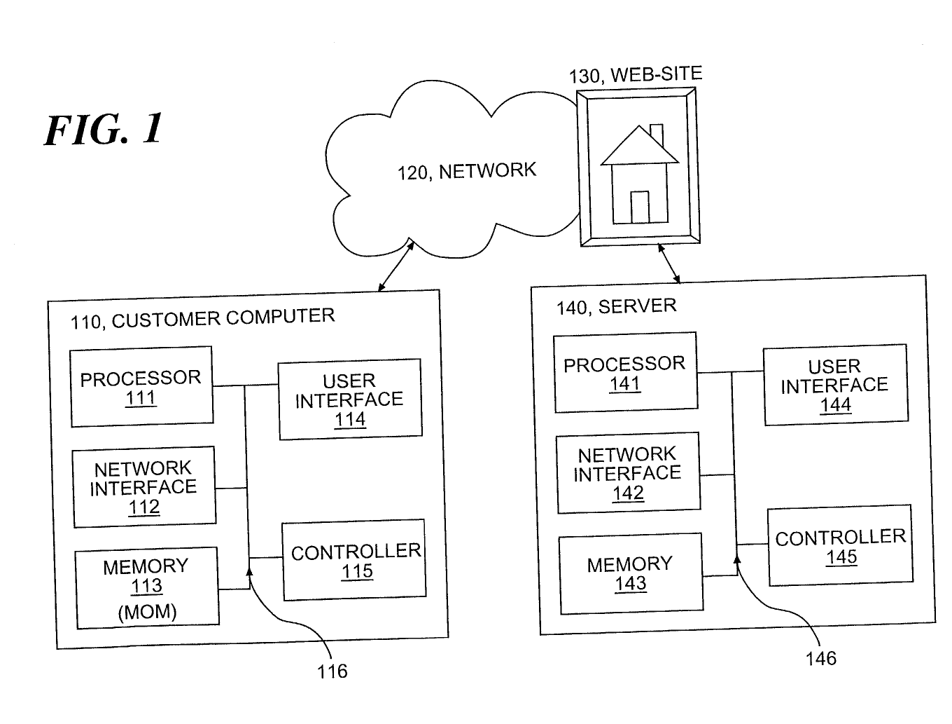

FIG. 1 is a diagram illustrating one exemplary computer network on which a system and method for providing a customer with various different samples of publications over a subscription period may be implemented. As shown in FIG. 1, the computer network 100 may include a customer computer 110, a communication network 120, which may be or include a publicly accessible network, e.g., the Internet. The communication network 120 may provide access to a Web-site 130 that is supported by a server 140.

As illustrated in FIG. 1, customer computer 110 may include a processor 111, a network interface 112, a memory 113, a user interface 114, a controller 115 and a communication/control bus 116. The bus 116 operatively couples elements 111-115 together so as to provide the capability of interacting with information and processes available via web-sites on the network 120. Each of elements 111-114 operates and cooperates under the control of the controller 115. The processor 111 executes program instructions stored in memory 113, for example, Magazineofthemonth.com (“MOM”) software or browser software, under the control of the controller 115. The customer computer 110 interacts with the network 120 using the network interface 112, which may be, for example, a conventionally available modem, under the control of the controller 115. Information may be output to, or received from, the customer computer user via the user interface 114, which may include, for example, a display, a key board, a speaker, a mouse, etc.

Customer computer 110 may be, for example, any one of a number of conventionally-known computer systems, such as a personal computer from IBM, Dell, etc. More generally, customer computer 110 may be any type of computing platform connected to a network that interacts with application programs.

As explained above, the Web operates on a client/server model. Therefore, the customer computer 110 may run browser software such as Netscape® Navigator or Microsoft®'s Internet Explorer on the customer computer 110. Such browser software may send its request for information or resources to a host (server computer), such as server 140 supporting web-site 130, where the server software processes the request. Included in the browser's request may be desired information or resources and the file formats the browser can accept.

Network 120 may be or include a privately or publicly accessible network, for example, the Internet. The server 140, which may be a single server or multiple servers, a server farm, etc., may include a processor 141, a network interface 142, a memory 143, a user interface 144, a controller 145, and a communication/control bus 146. The bus 146 operatively couples elements 141-145 together so as to provide the capability of hosting a web-site and interacting with other equipment via the network interface 142, which may be a conventionally available modem, and network 120. Each of elements 141-144 operates and cooperates under the control of the controller 145. For example, the processor 141 executes program instructions stored in memory 143 under the control of the controller 145. Information may be output to, or received from, the a server maintenance operator via the user interface 144, which may include, for example, a display, a keyboard, a speaker, a mouse, etc.

The memory 143 may also include databases including information related to products for sale at the web-site 130. Additionally, memory 143 may include data and program instructions that correspond to the generation of HTML pages included in the web-site.

In accordance with an exemplary embodiment of the invention, a customer can view information about various interest categories or themes of publications to determine whether s/he wants to subscribe to the category(s) of publications. One unique feature of the invention is it provides customers with opportunity to subscribe to different samples of publications over a subscription term, rather than subscribing to a single publication for a full-subscription term. By allowing the opportunity to review samples of various different publications included in the interest category, a would-be customer is provided with the opportunity to make a more informed decision regarding which publication(s) relating to a particular interest category is most appealing to him/her. As a result, when the customer is subsequently approached with the opportunity to order a full-term subscription to a particular publication, the customer is able to make a more informed decision and, therefore, may be more likely to purchase such a full-term subscription..

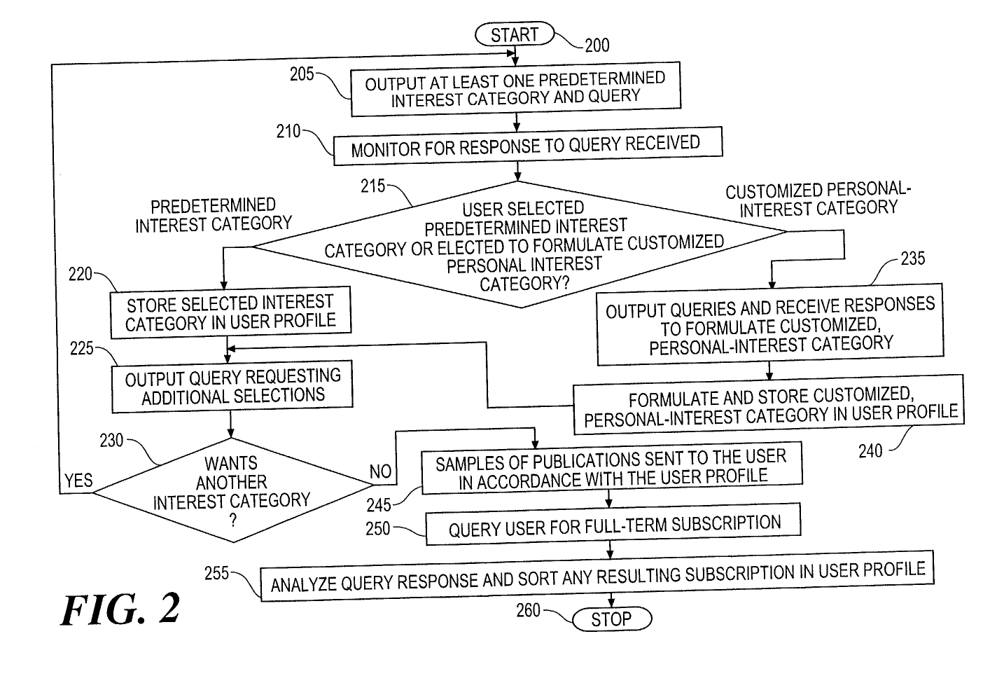

FIG. 2 is a flowchart illustrating one exemplary method of providing various different samples of publications to a customer over a subscription term. The method begins at 200 and control proceeds to 205. At 205, at least one predetermined interest category is output to the user along with a query requesting information whether the user would like to receive samples of publications related to the at least one predetermined interest category or whether the user would like to customize his/her own personal interest category. At 205, more than one interest category may be output for the user to review. Such interest categories may include, e.g., sports, hunting, cars, home, children, fashion, news, science, technology, finance, travel, etc.

Control then proceeds to 210, at which monitoring is performed to determine whether the user has selected the predetermined interest category, the user has elected to customize a personal interest category or the user has not responded to the output query. Control then proceeds to 215, at which a determination is made whether the user has selected a predetermined interest category, or has elected to customize a personal interest category. If the user has selected a predetermined interest category, control proceeds to 220, at which the selected interest category is stored in a user profile. Control then proceeds to 225, at which a query is output to the user requesting information whether the user wants to select another, additional interest category. Control then proceeds to 230, at which a determination is made based on the user's response to the query. If the user wants to select another category, control returns to 205. If the user does not want to select another category, control proceeds to 245.

If, at 215, it is determined that the user has elected to customize a personal interest category, control proceeds to 235, at which a series of queries are output to the user and responses received from the user so that the user is provided with the opportunity to select a number of specific interests, of which he/she will receive at least one sample of a publication from each specified interests during the sample-subscription period. It should be appreciated that, at 235, a user may alternatively have the option of selecting a number of specific publications, of which he/she will receive at least one of each during the sample-subscription period. Control then proceeds to 240, at which the customized personal interest category is formulated based on the user's selections and the customized personal interest category is stored in the user's user profile.

Control then proceeds to 225, at which a query is output to the user requesting information whether the user wants to select another, additional category. Control then proceeds to 230, at which the user's response to the query is analyzed. If the user wants to select another category, control returns to 205. If the user does not want to select another category, control proceeds to 245.

At 245, samples of publications included in the interest category(s) selected by the user are sent to the user for review during the sample-subscription period. For example, a different publication included in the selected interest category may be sent to the customer each month. Alternatively, it is foreseeable, that the same publication (different edition) may be sent to the user for more than one month, but for less than the full sample-subscription term. Such an alternative may be preferred, for example, when the user has selected an interest category that has only two or three corresponding publications available or, for example, if the user has formulated a customized personal interest category with only two or three publications included.

Following completion of the sample-subscription period (which may be, for example, six months, a year, etc.), control proceeds to 250, at which a query is output to the user regarding whether the user would like to subscribe for a full subscription term to one of the publications he/she received during the sample-subscription period. Control then proceeds to 255, at which the user's response to the query is analyzed and any resulting subscriptions are stored in the user profile. Control then proceeds to 260, at which the method ends.

It is important to note that the sample-subscription period need not be a fixed, predetermined period of time. Therefore, the sample-subscription may be three months, six months, a year, or a customized period of time set by the user during a user profile initialization process performed in conjunction with the method illustrated in FIG. 2.

Explanation will now be provided about how the order of publication editions corresponding to the selected interest categories may be determined. Based on the user's selected interest category, a different publication relating to the interest category may be delivered to the user each delivery cycle, e.g., day, week, month, quarter, etc., during the sample-subscription period. Determination of what order the publications are delivered during that sample-subscription period may be based on many different factors. For example, during selection of interest categories by the user, the user may be prompted to provide information regarding the order in which the publications should be delivered during the sample-subscription period. Alternatively, or in addition, the order may be determined in whole or in part, by the frequency with which publication editions are published. For example, a particular magazine may only be published quarterly whereas another magazine is published monthly.

Moreover, the order may be determined in whole, or in part, by requests of the publisher of the publications included in the interest category. For example, a publisher may request that a certain edition of a publication be provided to all individuals receiving the publication during the sample-subscription period because, for example, it is an extremely popular or comprehensive issue. For example, for the publication “American Rose,” their rose season might be in April and they want a minimum of 20,000 issues to be sent out in April because that is their strongest month. In such a situation, the publisher's request may be taken into account in determining in what order and when the samples of the publications included in the selected interest category are sent to the customers. Alternatively, a publisher may want to distribute the number of copies of a magazine uniformly or consistently over a subscription period, for example to stabilize printing requirements.

It is foreseeable that a customer's user profile, containing information about which publications he/she wishes to sample, in what order the sample publications should be delivered, etc., may be configured so that the customer does not receive the same publication in consecutive months. Such a configuration may be preferable if, for example, a particular interest category has only two publication titles. It should be appreciated that a minimum number of titles for each interest category may be set to two so as to distinguish a sample-subscription period from a full subscription period for a single publication. For example, for a “Bridal” interest category, there may only be three publications (A, B and C). Therefore, the user profile may be configured to ensure that any publication A, B and C does not get sent in consecutive months, such as AA, BB or CC. Alternatively, the user profile may be configured so that each of the three publications is received for delivery during consecutive delivery cycles over the sample-subscription period. For example, the publications may be delivered A, A, A, A, B, B, B, B, C, C, C. C over a sample-subscription period of twelve delivery cycles.

At the same time, the exemplary embodiments of the invention are capable of taking the above-identified publisher's requests for priority and ordering of publication delivery into account. In other words, the exemplary embodiments of the invention are capable of considering many different

All of the above-described information relating to a customer's user profile, various publication characteristics (frequency of publication, topic, size, format, etc.), and publisher's requests concerning various publication characteristics, may be stored in, for example, databases, included in memory 143 as shown in FIG. 1.

It is foreseeable that the processor 141 may access these databases to determine which publications a customer will likely be getting over the sample-subscription term. This information may be output to the customer during or following a process for subscribing to a sample-subscription period illustrated in FIG. 2. However, the output information need not include any indication of an order in which the various publications will be delivered during delivery cycles within the sample-subscription period. It is foreseeable that the output information may be provided to the customer, for example, via an electronic mail message or a letter. By not committing to an order of publication deliver, the exemplary embodiments of the invention are able to provide flexibility in case a publisher goes out of circulation, the order must be switched around or for other criteria to be met. Referring back to FIG. 2, at 245, publications are delivered to the customer during delivery cycles within the sample-subscription period. For example, each delivery cycle a determination of which publications are to be sent to which customers is made based on the information stored in memory 143 and a corresponding publication order is formulated.

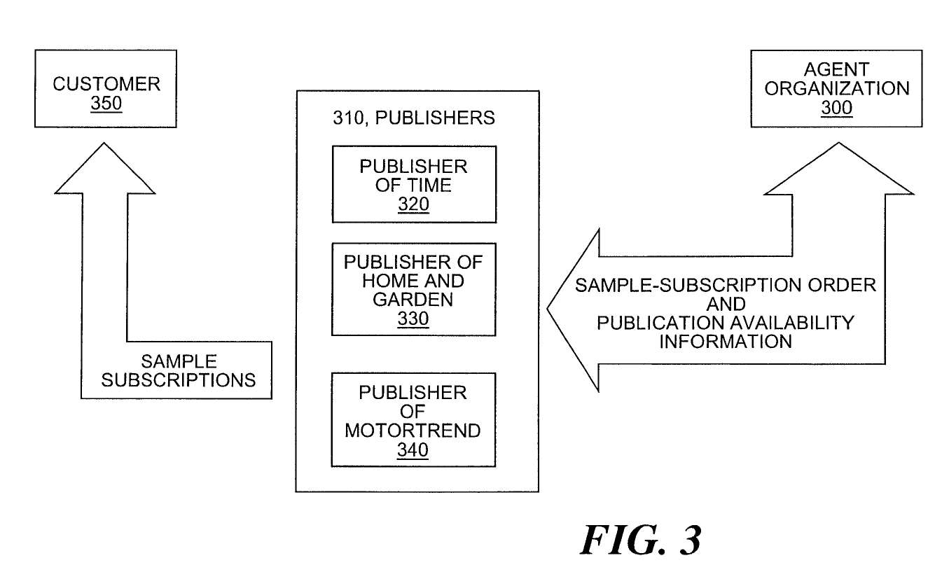

Referring to FIG. 3, the publication order is then sent from the agent organization 300 (e.g., the organization that operates and maintains the server 140 to support the web-site 130 illustrated in FIG. 1) that has taken the sample-subscription order to the publisher(s) 310 of the publications to be sent. These publishers 310 may include, for example, the publishers of TIME® 320, Home and Gardening® 330, and Motor Trend® 340, which then send the publications directly to the customer 350 rather than through the agent organization 300 that processed the order for the sample-subscriptions.

It is foreseeable that the publishers may request that they get the customers' names and addresses on physical labels. Therefore, it should be appreciated that such physical labels may be sent to the publishers, and/or, the information to be put on such labels may be transmitted to the publishers in electronic format (ASCII format), e.g., over the network 120.

It should be appreciated that the publishers 310 may also provide information to the agent organization 300 regarding publication availability, availability, requests for order of delivery, interest topics corresponding to various publications, etc.

The utility of the exemplary embodiments from a customer's perspective relates to the customer's opportunity to sample various different publications prior to committing to a full subscription term. Additionally, the customer has the ability to receive publications from different publishers during the sample-subscription period. The utility of the exemplary embodiments for a publisher's perspective relates to the publisher's ability to showcase their publications by providing customer's with the opportunity to preview the publications and compare the publications with other publications that are within the same interest category. Additionally, the publishers are provided with the opportunity to provide input and make requests about how and when publication editions should be delivered during sample-subscription periods.

More detailed explanation is now provided regarding how a customized personal interest category may be initialized. By initializing a customized interest category, a customer has the ability to choose which particular publications, or particular themes of publications, he/she would like to receive during the sample-subscription period. Moreover, it is foreseeable, that the user may be able to select which publications and/or which themes he/she will receive during a particular delivery cycle during the sample-subscription period. Once the customer has chosen the publications, or interest categories, a proposal may be formulated and output to the user of what publications or interest categories are to be delivered in each of the delivery cycles of the sample-subscription period. The customer can then review the proposal and, if approve, reject or propose modifications to the proposal, e.g., s/he wants the same interest categories (car, gardening, home decorating, etc.) but in a different order than the that provided in the proposal. It is foreseeable that such a situation may differ from a predetermined interest category in that the customer may have input regarding the delivery schedule of publications during the sample-subscription period. The, it is foreseeable that the customized interest category may be more customer-focused in that the customer can choose not just the categories but also the timing of when s/he receives the publications.

As stated above, a minimum number of publication titles in each interest category may be set to two or any greater number. Similarly, a minimum number of publications or interest categorizes to be included in a customized interest category may be set to two or any greater number.

It is also foreseeable that information within the user profile may be used to provide proposed interest categories or formulated customized, personal interest categories to a customer. Such proposals may be formulated based on information about the customer, for example, publications or interest categories they have selected in previous sample-subscription orders, personal information contained in their user profile, e.g., age, gender, income, occupation, geographic location, etc. Additionally, the customer can provide additional information upon which a proposal may be formulated. For example, the customer may respond to queries or volunteer information indicating that he/she is interested in the camping, horses, health, etc.

The order in which publications are delivered in accordance with a sample-subscription period with a customized, personal interest category may be similar to that of the sample-subscription period with a predetermined interest category described above. However, it should be appreciated that a determination of the order the publication delivery may be more complicated because, for example, there may be more than one interest category and the ordering may adjust accordingly as customers choose different interest categories and orders of receiving the interest categories. For example, as explained above, a customer may choose to receive a “car” related publication in January, “gardening” related publication in May, etc. Thus, the customer's preference may be a determining factor regarding when a publication or type of publication is delivered to the customer. Thus, one potential difference between a predetermined interest category and a customized personal interest category may be consideration of the customer's preference of the delivery order of sample publications.

It is foreseeable, that the sample-subscription delivery may be terminated at the request of the customer during any delivery cycle of the sample-subscription period. For example, at month six, the customer may determine that s/he likes a particular publication and does not want to continue receiving delivery of other publications during the rest of the sample-subscription period. It is foreseeable, that all or part of a remaining balance paid towards the sample-subscription period may be transferred or applied to a full-subscription term for the particular magazine. As a result, the customer need only pay the remaining balance. Such an option may be incorporated in conjunction with either a sample-subscription period with a predetermined interest category or with a customized, personal interest category.

While this invention has been described in conjunction with the specific exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

For example, it is foreseeable that a customer may be able to transfer back and forth between predetermined and customized, personal-interest categories.

Moreover, the exemplary embodiments of the invention may be used in conjunction with delivery of any product that is delivered on a period basis or any product that may be purchased on a subscription basis. For example, the exemplary embodiments may be implemented in conjunction with the purchase of flower seeds, wines, beers, foods, books, newspapers, movies, or anything that is delivered on a subscription basis.

One exemplary distinction between the exemplary embodiments of the invention and various other on-line Web-sites, for example, Bookofthemonth.com, Amazon.com, or Wineofthemonth.com, is that these organizations ship out the products themselves. In contrast, the exemplary embodiments of the invention may be utilized by an agent organization that has relationships with multiple product providers, e.g., publishers, manufacturers, etc., and the agent organization provides delivery labels or delivery label data, not products. The publishers ship the products as explained above. Exemplary embodiments of the invention provide a data-transferring network, among other things, that is unique to the subscription-based industry. As a result, the exemplary embodiments of the invention allow transmission of the information necessary for a manufacturer of a product to ship that product directly to the end-user of the product.

It should be appreciated that it is foreseeable that customers of the sample-subscription service may pay the agent organization for the service. The agent organization may pay the product manufactures, e.g., publishers. Additionally, the product-manufacturers may pay the agent organization for advertisements, marketing, commissions, etc.

It will be apparent to one of ordinary skill in the art that the embodiments as described above may be implemented in many different embodiments of software, firmware and hardware in the entities illustrated in the figures. The actual software code or specialized control hardware used to implement the present invention is not limiting of the present invention. Thus, the operation and behavior of the embodiments were described without specific reference to the specific software code or specialized hardware components, it being understood that a person of ordinary skill in the art would be able to design software and control hardware to implement the embodiments based on the description herein.

What is claimed:

1. A method for providing a user with samples of products during a sample-subscription period, the method comprising:
outputting at least one interest category for review by a user;
receiving information from the user indicating a selection of at least one interest category; and
requesting delivery of products corresponding to the selected at least one interest category to the user during the sample-subscription period.

2. The method of claim 1, further comprising outputting a query to the user requesting the user to subscribe to one of the products delivered during the sample-subscription period.

3. The method of claim 1, wherein the products are delivered from a product manufacturer to the user.

4. The method of claim 1, wherein an order in which the products are delivered during the sample-subscription period is based on availability of at least one of the products to be delivered to the user.

5. The method of claim 1, wherein an order in which the products are delivered during the sample-subscription period is based on information provided by the user, product availability and at least one product manufacturer's request.

6. The method of claim 1, wherein an order in which the products are delivered during the sample-subscription period is based on at least one product manufacturer's request.

7. The method of claim 1, wherein receiving information from the user indicating the selection of at least one interest category receives information indicating selection of two or more interest categories and requesting delivery of products requests delivery of at least two different products to the user during the sample-subscription period based on the selected interest categories.

8. The method of claim 7, further comprising outputting a query to the user requesting the user to subscribe to one of the products delivered during the sample-subscription period.

9. The method of claim 7, wherein the products are delivered directly from the product manufacturer to the user.

10. The method of claim 7, wherein an order in which the products are delivered during the sample-subscription period is based on availability of at least one of the products to be delivered to the user.

11. The method of claim 7, wherein an order in which the products are delivered during the sample-subscription period is based on a request of the user.

12. The method of claim 7, wherein an order in which the products are delivered during the sample-subscription period is based on a request of the user, availability at least one product to be delivered to the user and a request of at least one product manufacturer.

13. The method of claim 7, wherein an order in which the products are delivered during the sample-subscription period is based on at least one product manufacturer's request.

14. A method for providing a user with samples of products during a sample-subscription period, the method comprising:
outputting a plurality of interests for review by a user;
receiving information from the user indicating a selection of at least two interests from the plurality of interests;
formulating a customized, personal interest category based on the selected at least two interests selected by the user; and
requesting delivery of products corresponding to the customized, personal interest category to the user during the sample-subscription period.

15. The method of claim 14, further comprising outputting a query to the user requesting the user to subscribe to one of the products delivered during the sample-subscription period.

16. A method of claim 14, wherein the products are delivered from a product manufacturer to the user.

17. The method of claim 14, wherein an order in which the products are delivered during the sample-subscription period is based on availability of at least one of the products to be delivered to the user.

18. The method of claim 14, wherein an order in which the products are delivered during the sample-subscription period is based on a request of the user, availability of at least one product to be delivered to the user and a request of at least one product manufacturer.

20. The method of claim 14, further comprising:
determining at least one interest corresponding to at least one product; and
formulating and outputting a proposed order in which products are delivered to the user during the sample-subscription period based on the determined at least one interest.

21. The method of claim 20, wherein the proposed order in which the products are delivered to the customer during the sample-subscription period may be altered by a request from the user.

21. The method of claim 14, wherein an order in which the products are delivered during the sample-subscription period is based on information provided by the user frequency of publications, and publishers' requests.

23. A system for providing a customer with samples of products during a sample-subscription period, the system comprising:
an interface that outputs information to and receives information from the user, wherein the interface receives information from the user indicating selection of at least one interest category; and
a processor, coupled to the interface, that analyzes the information received from the user and requests delivery of products corresponding to the selected at least one interest category to the user during the sample-subscription period.

24. The system of claim 23, further comprising a memory, operationally coupled to the processor and the interface, that stores a user profile including the at least one interest category selected by the user.

25. The system of claim 23, wherein the interface is a web-page.

26. The system of claim 23, wherein an order in which the products are delivered during the sample-subscription period is based on availability of at least one of the products to be delivered to the user.

27. The system of claim 23, wherein an order in which the products are delivered during the sample-subscription period is based on information provided by the user, availability of at least one product to be delivered to the user and a request of at least one product manufacturer.

28. The system of claim 23, wherein the information received from the user that indicates the selection of at least one interest category receives information indicating selection of two or more interest categories and the request of delivery of products requests delivery of at least two different products to the user during the sample-subscription period based on the selected interest categories.

29. The system of claim 28, wherein the processor outputs a query to the user via the interface requesting the user to subscribe to one of the products delivered during the sample-subscription period.

30. The system of claim 28, wherein the products are delivered directly from the product manufacturer to the user.

31. The system of claim 28, wherein an order in which the products are delivered during the sample-subscription period is based on availability of at least one of the products to be delivered to the user.

32. The system of claim 28, wherein an order in which the products are delivered during the sample-subscription period is based on a request of the user.

33. The system of claim 28, wherein an order in which the products are delivered during the sample-subscription period is based on a request of the user, availability of at least one product to be delivered and at least one request of at least one product manufacturer.

34. The system of claim 28, wherein an order in which the products are delivered during the sample-subscription period is based on at least one product manufacturer's request.

35. A system for providing a user with samples of products during a sample-subscription period, the system comprising:
an interface that outputs information to and receives information from the user, wherein the interface outputs a plurality of interests for review by the user and receives information from the user indicating selection of at least two interests from the plurality of interests; and
a processor, coupled to the interface, that analyzes the information received from the user, formulates a customized, personal interest category based on the selected at least two interests selected by the user and requests delivery of products corresponding to the selected at least one interest category to the user during the sample-subscription period.

36. The system of claim 35, wherein the processor outputs a query to the user via the interface requesting the user to subscribe to one of the products delivered during the sample-subscription period.

37. The system of claim 35, wherein the products are delivered from a product manufacturer to the user.

38. The system of claim 35, wherein an order in which the products are delivered during the sample-subscription period is based on availability of at least one of the products to be delivered to the user.

39. The system of claim 35, wherein an order in which the products are delivered during the sample-subscription period is based on a request of the user, availability of at least one of the products to be delivered to the user and a request of at least one product manufacturer.

40. The system of claim 35, wherein the processor determines at least one interest corresponding to at least one product and formulates and outputs a proposed order to the user via the interface in which products are delivered to the user during the sample-subscription period based on the determined at least one interest.

41. The system of claim 40, wherein the proposed order in which the products are delivered to the customer during the sample-subscription period may be altered by a request from the user received via the interface.

42. The system of claim 35, wherein an order in which the products are delivered during the sample-subscription period is based on information provided by the user, availability of at least one product to be delivered to the user and at least one request of at least one product manufacturer.
